(19) United States
(12) Patent Application Publication
(10) Pub. No.: US 2011/0077372 A1
(43) Pub. Date: Mar. 31, 2011

(54) Ether-containing cyclic structure-containing polymer, polymer composition for optical material, and molded article thereof, optical component and lens

(75) Inventors: Seiya Sakurai, Ashigarakami-gun (JP); Rie Okutsu, Ashigarakami-gun (JP)

(73) Assignee: FUJIFILM Corporation, Tokyo (JP)

(21) Appl. No.: 12/923,402

(22) Filed: Sep. 20, 2010

(30) Foreign Application Priority Data
Sep. 28, 2009 (JP) 2009-222201

(51) Int. Cl. C08F 228/06; C08F 224/00

(52) U.S. Cl. 526/256; 526/268

(57) ABSTRACT

Disclosed is an ether-containing cyclic structure-containing polymer derived from a monomer represented by formula (1) below, or derived from a monomer represented by formula (1) below and a single or more species of cyclic olefinic monomer(s), having a refractive index of equal to or larger than 1.53 and an Abbe number of equal to or larger than 56. Each of R¹¹ to R¹⁴ independently represents a hydrogen atom or a substituent, or R¹¹ to R¹⁴ may bond with each other to form a cyclic structure; each of X and Y independently represents a substituted or non-substituted, carbon atom, oxygen atom, or sulfur atom; and m represents 0 or 1.

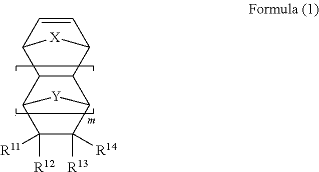

### CROSS-REFERENCE TO RELATED APPLICATIONS

This application claims benefit of priority under 35 U.S.C. 119 to Japanese Patent Application No. 2009-222201 filed on Sep. 28, 2009; and the entire contents of the application are incorporated herein by reference.

### BACKGROUND OF THE INVENTION

1. Field of the Invention

The present invention relates to an ether-containing cyclic structure-containing polymer and polymer composition for optical material having large Abbe number, large refractive index, high transparency, light weight, good workability, and good mold releasing property from dies; and optical components such as lens (for example, lenses composing spectacle lens, lens for optical instruments, optoelectronic lens, lens for laser instruments, optical pickup lens, vehicle-borne camera lens, mobile camera lens, digital camera lens, OHP lens, micro-lens array, etc.) containing the same.

2. Related Art

Transparent resin materials have advantages over glasses, in terms of lighter weight, higher impact resistance, better moldability, and higher economical efficiency. In recent years, plastics have increasingly been substituting optical glasses, typically in the field of optical components including lens.

Polycarbonate resin is known as a representative of transparent thermoplastic resin, and those derived from 2,2-bis(4-hydroxyphenyl)propane (so-called bisphenol A) are applied to optical components in various fields, by virtue of their excellent transparency, lighter weight as compared with glasses, excellent impact resistance, and readiness of mass production based on their melt moldability. While the refractive index is relatively as high as 1.58 or around, Abbe number which represents the degree of dispersion of refractive index is as small as 30. The polycarbonate resin has therefore been limited in the applicability at present, due to its poor balance between the refractive index and dispersion characteristics. For example, it has been known that the source material of spectacle lens, which is a representative of the optical component, preferably has an Abbe number of 40 or larger, in consideration of visual function, but it has been difficult to obtain desired characteristics even if the polycarbonate resin derived from bisphenol A were used without modification.

By the way, distortions possibly generate in optical systems of image capturing instruments include monochromatic abberation and chromatic abberation, exemplified by spherical abberation, comatic abberation, astigmatism, distortion and field curvature. In particular, increase in the chromatic abberation results in larger blur, and consequently degrades color image quality to an extreme degree. It has been known that correction of the chromatic abberation may be improved by a combination lens system which includes lenses having high refractive index and lenses having large Abbe number are combined.

On the other hand, cyclic olefinic resins have been known as optical resin materials having Abbe numbers relatively as large as 55 to 56 or around, but only with refractive indices of as small as 1.52 to 1.53. Materials having larger refractive indices have, therefore, been desired from the viewpoint of recent weight reduction and downsizing of mobile instruments.

JP-B No. H06-5323 describes optical resin materials using polythiol compounds. While polymers described in Examples of this publication have refractive indices of as large as 1.58 to 1.66, the Abbe numbers are only as small as 32 to 43, which are largely inferior to those of the above-described cyclic olefinic resins.

JP-A No. 2007-9178 describes a ring-opened polymer of sulfur-containing cyclic olefin. Polymers described in Examples of the publication have refractive indices of as large as 1.56 to 1.657, whereas Abbe numbers of 20 to 47, which are smaller than those of the above-described cyclic olefinic resins.

While resin materials described in the above-described documents have Abbe numbers of sufficient levels required for spectacle lens materials, but are insufficient for lens materials for recent mobile instruments which require larger Abbe numbers. Optical resin materials successfully improved in the refractive index, without being significantly reduced in the Abbe number have not been discovered yet, and there has therefore been a strong need for the development. On the other hand, it is important for such optical component materials to be excellent not only in the optical characteristics, but also in characteristics relevant to molding, such as mold releasing property and moist-heat resistance.

JP-A Nos. 2007-131703, 2003-34706 and 2005-290048 give descriptions on ether-containing cyclic structure-containing polymers, intended for applications different from lens, while giving no description on the refractive index and Abbe number.

### SUMMARY OF THE INVENTION

One object of the present invention is to provide a novel ether-containing cyclic structure-containing polymer and a polymer composition for optical materials, useful as a source material of optical components, and applications of the same.

It is another object of the present invention to provide an ether-containing cyclic structure-containing polymer and a polymer composition for optical material, high in both of Abbe number and refractive index, and excellent also in the mold releasing property and moist-heat resistance, and applications of the same.

The means for achieving the above-described objects are as follows.
[1] An ether-containing cyclic structure-containing polymer derived from an ether-containing cyclic monomer represented by formula (1) below, or derived from an ether-containing cyclic monomer represented by formula (1) below and a single or more species of cyclic olefinic monomer(s), having a refractive index of 1.53 or larger and an Abbe number of 56 or larger:

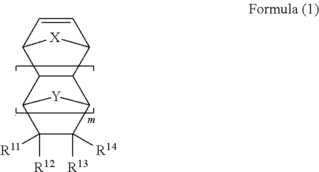

where each of R¹¹ to R¹⁴ independently represents a hydrogen atom, substituted or non-substituted alkyl group, or oxygen atom-containing substituent, R¹¹ to R¹⁴ may bond with each other to form a cyclic structure, where, any one of R¹¹ to R¹⁴ is a substituent containing a cyclic ether structure having oxygen atoms(s) as one of the ring-composing atoms, or alternatively, at least two of R¹¹ to R¹⁴ bond with each other to form a cyclic ether structure having oxygen atoms(s) as one of the ring-composing atoms; each of X and Y independently represents a substituted or non-substituted, carbon atom, oxygen atom, or sulfur atom; and m represents 0 or 1.
[2] The ether-containing cyclic structure-containing polymer of [1], wherein the single or more species of cyclic olefinic monomer is a monomer represented by formula (4) below:

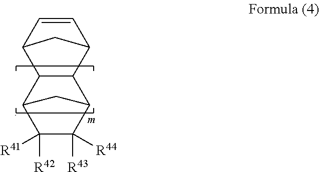

where each of R⁴¹ to R⁴⁴ independently represents a hydrogen atom, or substituted or non-substituted alkyl group; and m represents 0 or 1.
[3] The ether-containing cyclic structure-containing polymer of [2], wherein the monomer represented by formula (4) is an alkyl-substituted norbornene, or a monomer represented by the formula below:

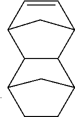

[4] An ether-containing cyclic structure-containing polymer derived from the ether-containing cyclic monomer represented by formula (1), and a monomer represented by formula (2) below and/or a precursor thereof, and having a refractive index of equal to or larger than 1.55 and an Abbe number of equal to or larger than 50:

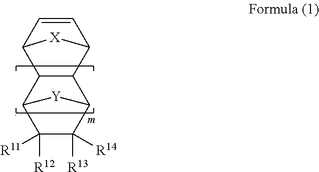

where each of R¹¹ to R¹⁴ independently represents a hydrogen atom, substituted or non-substituted alkyl group, or oxygen atom-containing substituent, R¹¹ to R¹⁴ may bond with each other to form a cyclic structure, where, any one of R¹¹ to R¹⁴ is a substituent containing a cyclic ether structure having oxygen atoms(s) as one of the ring-composing atoms, or alternatively, at least two of R¹¹ to R¹⁴ bond with each other to form a cyclic ether structure having oxygen atoms(s) as one of the ring-composing atoms; each of X and Y independently represents a substituted or non-substituted, carbon atom, oxygen atom, or sulfur atom; and m represents 0 or 1;

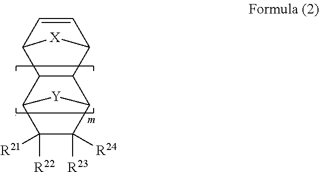

where each of R²¹ to R²⁴ independently represents a hydrogen atom, substituted or non-substituted alkyl group, or a substituent containing an oxygen atom or sulfur atom, R²¹ to R²⁴ may bond with each other to form a cyclic structure, where, any one of R²¹ to R²⁴ represents a substituent containing a sulfur-containing cyclic structure having sulfur atom(s) as one of the ring-composing atoms, or alternatively, any two or more of R²¹ to R²⁴ may bond with each other to form a sulfur-containing cyclic structure having sulfur atoms(s) as one of the ring-composing atoms; each of X and Y independently represents a substituted or non-substituted, carbon atom, oxygen atom, or sulfur atom; and m represents 0 or 1.
[5] The ether-containing cyclic structure-containing polymer of [4], wherein the monomer represented by formula (2) is a compound represented by formula (2a) below, or a precursor of the monomer represented by formula (2) is a compound represented by the formula (2b) below:

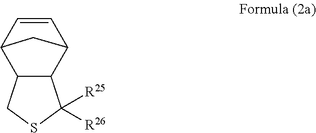

where each of R²⁵ and R²⁶ independently represents a hydrogen atom, substituted or non-substituted alkyl group, and R²⁵ and R²⁶ may bond with each other to form a 5- or 6-membered alicyclic hydrocarbon ring;

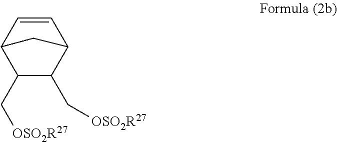

where R²⁷ represents a C₁₋₁₀ alkyl group.
[6] A polymer derived from the ether-containing cyclic monomer represented by formula (1), and a monomer represented by formula (3) below, and having a refractive index of 1.42 or larger and an Abbe number of 65 or larger:

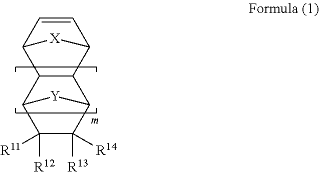

where each of R¹¹ to R¹⁴ independently represents a hydrogen atom, substituted or non-substituted alkyl group, or oxygen atom-containing substituent, R¹¹ to R¹⁴ may bond with each other to form a cyclic structure, where, any one of R¹¹ to R¹⁴ is a substituent containing a cyclic ether structure having oxygen atoms(s) as one of the ring-composing atoms, or alternatively, at least two of R¹¹ to R¹⁴ bond with each other to form a cyclic ether structure having oxygen atoms(s) as one of the ring-composing atoms; each of X and Y independently represents a substituted or non-substituted, carbon atom, oxygen atom, or sulfur atom; and m represents 0 or 1;

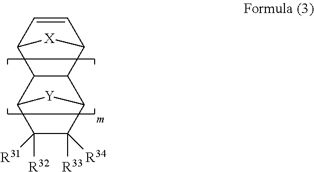

where each of R³¹ to R³⁴ independently represents a hydrogen atom, fluorine atom, substituted or non-substituted alkyl group, fluorine atom-containing alkyl group, fluorine atom-containing alkoxy group, fluorine atom-containing ether bond-containing alkyl group, —COOR⁵, or —OCOR⁵; R³¹ to R³⁴ may bond with each other to form a cyclic structure, where, at least one of R³¹ to R³⁴ contains a fluorine atom; R⁵ represents a substituted or non-substituted alkyl group, or fluorine atom-containing alkyl group; each of X and Y independently represents a substituted or non-substituted, carbon atom, oxygen atom, or sulfur atom; and m represents 0 or 1.
[7] The ether-containing cyclic structure-containing polymer of [6], wherein in formula (3), at least one of R³¹ to R³⁴ represents a C₁₋₁₀ perfluoroalkyl group.
[8] The ether-containing cyclic structure-containing polymer of any one of [1]-[7], wherein the ether-containing cyclic monomer represented by formula (1) is a monomer represented by formula (1a) below:

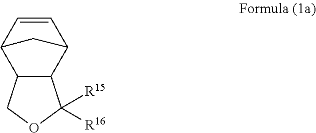

where each of R¹⁵ and R¹⁶ independently represents a hydrogen atom, substituted or non-substituted alkyl group, and, R¹⁵ and R¹⁶ may bond with each other to form a 5- or 6-membered alicyclic hydrocarbon ring.
[9] The ether-containing cyclic structure-containing polymer of any one of [1]-[8], wherein the ether-containing cyclic monomer represented by formula (1) is a monomer represented by formula M-1 below:

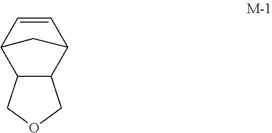

[10] The ether-containing cyclic structure-containing polymer of any one of [1]-[9], obtained by addition polymerization of the monomer described in any one of [1]-[9].
[11] The ether-containing cyclic structure-containing polymer of any one of [1]-[9], obtained by ring-opening metathesis polymerization of the monomer described in any one of [1]-[9], and subsequent hydrogenation.
[12] The ether-containing cyclic structure-containing polymer of any one of [1]-[11], having a glass transition temperature of equal to or higher than 100° C.
[13] The ether-containing cyclic structure-containing polymer of any one of [1]-[12], having a weight-average molecular weight of equal to or larger than 20,000.
[14] A polymer composition for optical material, comprising an ether-containing cyclic structure-containing polymer of any one of [1]-[13].
[15] The ether-containing cyclic structure-containing polymer of any one of [1]-[13], or a polymer composition for optical material of [14], having a transmissivity of light of equal to or larger than 50% based on a 1-mm thick equivalence measured at a wavelength of 589 nm.
[16] A molded article, obtained by molding an ether-containing cyclic structure-containing polymer of any one of [1]-[13], or a polymer composition for optical material of [14].
[17] An optical component, obtained by molding an ether-containing cyclic structure-containing polymer of any one of [1]-[13], or a polymer composition for optical material of [14].
[18] A lens, obtained by molding an ether-containing cyclic structure-containing polymer of any one of [1]-[13], or a polymer composition for optical material of [14].

### DETAILED DESCRIPTION OF THE INVENTION

The present invention will be detailed below. Note that, in this patent specification, all numerical ranges expressed using “to” mean ranges including the numerals placed therebefore and thereafter as the lower limit value and the upper limit value, respectively.

### 1. Ether-Containing Cyclic Structure-Containing Polymer

The present invention relates to an ether-containing cyclic structure-containing polymer. The ether-containing cyclic structure-containing polymer of the present invention not only successfully achieves large values both in the Abbe number and refractive index, but also satisfies desirable levels of mold releasing property and heat resistance, which are characteristics required for molding.

### (1) First Ether-Containing Cyclic Structure-Containing Polymer

The present invention relates to an ether-containing cyclic structure-containing polymer derived from an ether-containing cyclic monomer represented by formula (1) below, or derived from the ether-containing cyclic monomer represented by formula (1) below and a single or more species of cyclic olefinic monomer(s), having a refractive index of equal to or larger than 1.53 and an Abbe number of equal to or larger than 56 (referred to as “first ether-containing cyclic structure-containing polymer”, hereinafter).

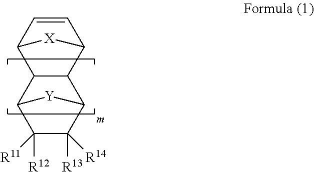

In formula (1), each of R¹¹ to R¹⁴ independently represents a hydrogen atom, substituted or non-substituted alkyl group, or oxygen atom-containing substituent. R¹¹ to R¹⁴ may bond with each other to form a cyclic structure, where, any one of R¹¹ to R¹⁴ is a substituent containing a cyclic ether structure having oxygen atoms(s) as one of the ring-composing atoms, or alternatively, at least two of R¹¹ to R¹⁴ bond with each other to form a cyclic ether structure having oxygen atoms(s) as one of the ring-composing atoms. Each of X and Y independently represents a substituted or non-substituted, carbon atom, oxygen atom, or sulfur atom. m represents 0 or 1.

The number of carbon atoms of the substituted or non-substituted alkyl group represented by each of R¹¹ to R¹⁴ is preferably 1 to 16, and more preferably 1 to 12. Examples of the substituent include methyl group, ethyl group, propyl group, butyl group, hexyl group, and so forth.

Examples of the substituents having oxygen atom(s) include ether bond-containing alkyl group (more specifically, substituted or non-substituted alkoxy group, and substituted or non-substituted (poly)alkyleneoxyalkyl group), —COOR¹⁷, and —OCOR¹⁷. R¹⁷ represents a substituted or non-substituted alkyl group. Examples of the substituents possibly owned by them are same as those possibly owned by R¹¹ to R¹⁴. Also preferable ranges of the number of carbon atoms of the alkyl chain contained in these groups are same as the number of carbon atoms contained in R¹¹ to R¹⁴. The number of carbon atoms of the alkylene chain in (poly)alkyleneoxy chain is preferably 2 to 4.

Note that, any one of R¹¹ to R¹⁴ is a substituent containing a cyclic ether structure having oxygen as one of the ring-composing atoms, or alternatively, at least two of R¹¹ to R¹⁴ bond with each other to form a cyclic ether structure having oxygen as one of the ring-composing atoms. The cyclic ether structure is preferably a 5- or 6-membered ring.

Examples of the cyclic ether structure formed by bonding of at least two of R¹¹ to R¹⁴ include the followings. Note that “*” in the formulae indicates a site of bonding with the ring illustrated in formula (1).

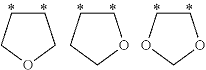

Examples of the substituent containing a cyclic ether structure having oxygen as one of the ring-composing atoms, represented by any one of R¹¹ to R¹⁴, include the groups illustrated below, but not limited thereto. Note that “*” in the formulae indicates a site of coupling directly, or via a single bond, with the ring structure illustrated in formula (1).

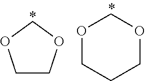

In formula (1), each of X and Y independently represents a substituted or non-substituted, carbon atom, oxygen atom, or sulfur atom, preferably a non-substituted carbon atom or oxygen atom, and more preferably a non-substituted carbon atom.

Examples of the ether-containing cyclic monomer represented by formula (1) include the monomers represented by formula (1 a) below:

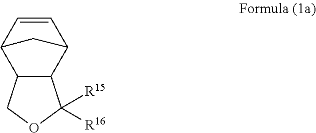

In formula (1a), each of R¹⁵ and R¹⁶ independently represents a hydrogen atom, substituted or non-substituted alkyl group, and, R¹⁵ and R¹⁶ may bond with each other to form a 5- or 6-membered alicyclic hydrocarbon ring.

Preferable examples of the substituted or non-substituted alkyl group respectively represented by R¹⁵ and R¹⁶ are same as those of substituted or non-substituted alkyl group respectively represented by R¹¹ to R¹⁴ in formula (1). The same will apply also to the preferable ranges of the number of carbon atoms, and preferable examples of the substituents.

Examples of the 5- or 6-membered alicyclic hydrocarbon ring formed by bonding of R¹⁵ and R¹⁶ with each other include substituted or non-substituted cyclopentane ring, and substituted or non-substituted cyclohexane ring. Preferable examples of the substituents are same as those of the substituents possibly owned by each of R¹¹ to R¹⁴. These rings are preferably non-substituted.

Examples of repeating unit derived from the ether-containing cyclic monomer represented by formula (1) will be shown below. The examples, however, are not limited thereto.

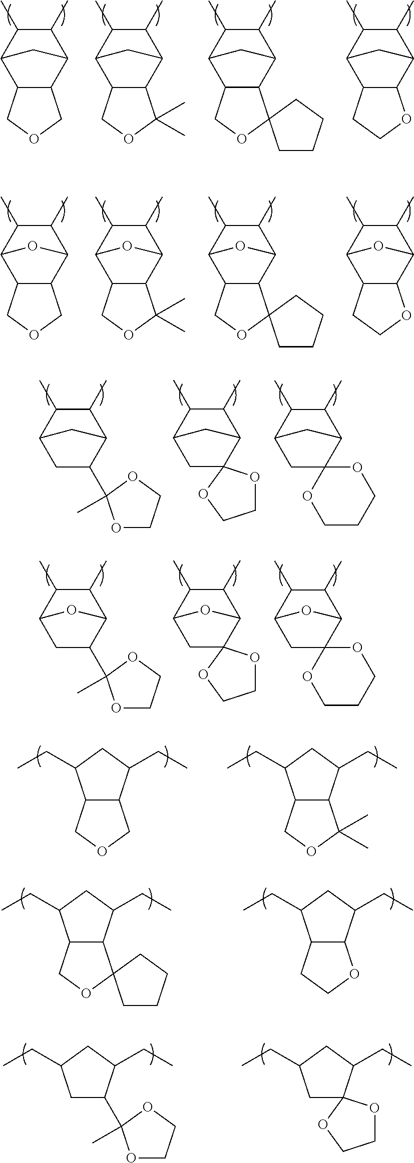

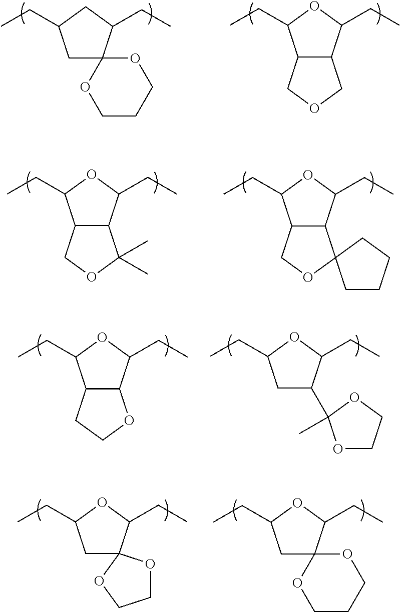

One embodiment of the first ether-containing cyclic structure-containing polymer is derived from the ether-containing cyclic monomer represented by formula (1) in the above, and a single or more species of cyclic olefinic monomer (the cyclic olefinic monomer may be the ether-containing, cyclic structure-containing monomer represented by the formula in the above, or may be some other cyclic olefinic monomer). The cyclic olefinic monomer is not specifically limited. Preferable examples of the cyclic olefinic monomer include those represented by formula (4) below:

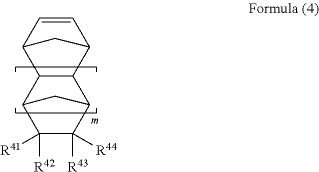

In formula (4), each of R⁴¹ to R⁴⁴ respectively represents a hydrogen atom, or substituted or non-substituted alkyl group; and m represents 0 or 1.

Examples of the substituted or non-substituted alkyl group represented by R⁴¹ to R⁴⁴ are same as the substituted or non-substituted alkyl group represented by R¹¹ to R¹⁴ in the formula (1). The same will apply also to the preferable ranges of the number of carbon atoms of the alkyl group, and preferable examples of the substituent.

Examples of the monomer represented by the formula (4) includes alkyl-substituted (preferably C₁₋₁₀ alkyl-substituted) norbornene, monomer represented by the formula below:

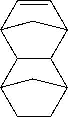

tetracyclododecene, hexyl norbornene, and butyl norbornene, but are not limited thereto.

In the first ether-containing cyclic structure-containing polymer of the present invention, ratio of the ether-containing cyclic monomer represented by formula (1) is not specifically limited. Also a polymer derived only from the ether-containing, cyclic monomer represented by formula (1) is acceptable.

In an embodiment of the polymer containing a unit derived from a single or more species of cyclic olefinic monomer, ratio of the ether-containing cyclic monomer represented by formula (1) is preferably 20 to 80 mol %, and more preferably 30 to 70 mol %.

### (2) Second Ether-Containing Cyclic Structure-Containing Polymer

The present invention relates to an ether-containing cyclic structure-containing polymer derived from the ether-containing cyclic monomer represented by formula (1), and a monomer represented by formula (2) below and/or a precursor thereof, and having a refractive index of equal to or larger than 1.55 and an Abbe number of equal to or larger than 50 (referred to as “second ether-containing cyclic structure-containing polymer”, hereinafter). Note that the “precursor of the monomer represented by formula (2)” in the context of this specification means a compound containing no sulfur-containing ring structure before being polymerized, but gives a repeating unit derived from the compound represented by formula (2) having the sulfur-containing ring structure after being polymerized. Representative examples include the compounds represented by formula (2b) described later.

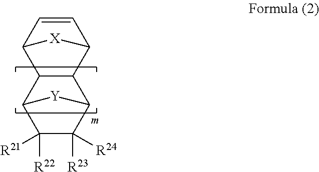

In formula (2), each of R²¹ to R²⁴ independently represents a hydrogen atom, substituted or non-substituted alkyl group, or a substituent containing an oxygen atom or sulfur atom. R²¹ to R²⁴ may bond with each other to form a cyclic structure, where, any one of R²¹ to R²⁴ represents a substituent containing a sulfur-containing cyclic structure having sulfur atom(s) as one of the ring-composing atoms, or alternatively, any two or more of R²¹ to R²⁴ may bond with each other to form a sulfur-containing cyclic structure having sulfur as one of the ring-composing atoms. Each of X and Y independently represents a substituted or non-substituted, carbon atom, oxygen atom, or sulfur atom. m represents 0 or 1.

Preferable examples of the substituted or non-substituted alkyl group respectively represented by R²¹ to R²⁴ are same as the substituted or non-substituted alkyl group respectively represented by R¹¹ to R¹⁴ in formula (1). The same will apply also to the preferable ranges of the number of carbon atoms of the alkyl group, and preferable examples of the substituent.

The oxygen atom-containing substituent respectively represented by R²¹ to R²⁴ is same as the oxygen atom-containing substituent respectively represented by R¹¹ to R¹⁴ in formula (1). The same will apply also to the preferable ranges.

Examples of the sulfur atom-containing substituent respectively represented by R²¹ to R²⁴ include thioether bond-containing alkyl group (more specifically, substituted or non-substituted alkylthio group, and substituted or non-substituted alkylene sulfide alkyl group (-alkylene-S-alkyl)), and —OSO₂R²⁷. R²⁷ represents a substituted or non-substituted alkyl group. Examples of substituent possibly owned by them are same as those possibly owned by R¹¹ to R¹⁴. Also preferable ranges of the number of carbon atoms of the alkyl chain contained in these groups are same as the number of carbon atoms contained in R¹¹ to R¹⁴. The number of carbon atoms of the alkylene chain in the alkylene sulfide alkyl group (-alkylene-S-alkyl) is preferably 2 to 4.

Note that, any one of R²¹ to R²⁴ represents a substituent containing a sulfur-containing cyclic structure having sulfur atom(s) as one of the ring-composing atoms, or alternatively, any two or more of R²¹ to R²⁴ bond with each other to form a sulfur-containing cyclic structure having sulfur atoms(s) as one of the ring-composing atoms. The sulfur-containing ring structure is preferably a 5- or 6-membered ring. Examples of the sulfur-containing ring structure formed by bonding of at least two of R²¹ to R²⁴ include the structures below. Note that, “*” in the formulae indicates a site of coupling directly, or via a single bond, with the ring structure illustrated in formula (2).

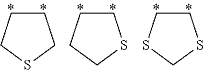

Examples of the substituent containing a sulfur-containing cyclic structure having sulfur atom(s) as one of the ring-composing atoms, represented by any one of R²¹ to R²⁴, include the groups illustrated below, but are not limited thereto. Note that “*” in the formulae indicates a site of coupling directly, or via a single bond, with the ring structure illustrated in formula (2).

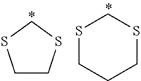

In formula (2), each of X and Y independently represents a substituted or non-substituted, carbon atom, oxygen atom, or sulfur atom, wherein non-substituted, carbon atom or oxygen atom is preferable, and non-substituted carbon atom is more preferable.

Examples of the monomer represented by formula (2) include the monomers represented by formula (2a) below:

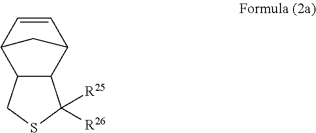

In formula (2a), each of R²⁵ and R²⁶ independently represents a hydrogen atom, substituted or non-substituted alkyl group. R²⁵ and R²⁶ may bond with each other to form a 5- or 6-membered alicyclic hydrocarbon ring. Preferable examples of the substituted or non-substituted alkyl group respectively represented by R²⁵ and R²⁶ in formula (2a) are same as the substituted or non-substituted alkyl group respectively represented by R¹¹ to R¹⁴ in formula (1). The same will apply also to the preferable ranges of the number of carbon atoms, and preferable examples of the substituent.

Examples of the 5- or 6-membered alicyclic hydrocarbon ring formed by bonding of R²⁵ and R²⁶ with each other include substituted or non-substituted cyclopentane ring, and substituted or non-substituted cyclohexane ring. Preferable examples of the substituent are same as those of the substituent possibly owned by each of R¹¹ to R¹⁴. The rings are preferably non-substituted.

Examples of the precursor of the monomer represented by formula (2) include any compounds which are capable of yielding a repeating unit of the sulfur-containing ring structure, but in which none of R²¹ to R²⁴ in formula (2) has a sulfur-containing ring structure having sulfur atom(s) as one of the ring-composing atoms before being polymerized; and examples of the precursor of the monomer represented by formula (2) include also any compounds in which two or more of R²¹ to R²⁴ bond with each other to form a sulfur-containing cyclic structure having sulfur atom(s) as one of the ring-composing atoms.

Preferable examples of the precursor include those having —OSO₂R²⁷ as each of R²¹ and R²³, and having a hydrogen atom as each of R²² and R²⁴. R²⁷ represents a substituted or non-substituted alkyl group. Examples of the substituent possibly owned by them are same as those of the substituent possibly owned by R¹¹ to R¹⁴. Also preferable ranges of the number of carbon atoms of the alkyl chain contained in these groups are same as the preferable ranges of the number of carbon atoms contained in R¹¹ to R¹⁴.

Examples of the precursor of the monomer represented by formula (2) include the compounds represented by formula (2b) below:

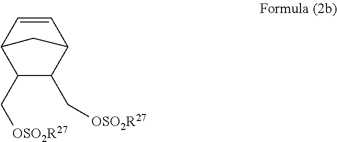

In formula (2b), R²⁷ represents a C₁-₁₀ (preferably C₁₋₅) alkyl group.

Specific examples of the precursor represented by formula (2b) include compound M-2 below, and the examples represented by formula (2a) include compound M-3 below:

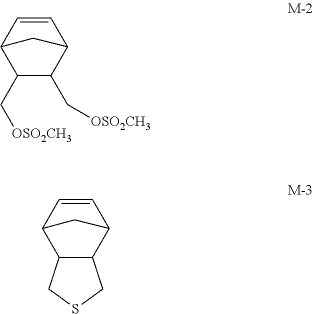

Preferable and specific examples of the repeating unit containing sulfur-containing ring structure, derived from the monomer represented by formula (2) or the precursor thereof, adoptable to the present invention, will be enumerated below, but are not limited thereto.

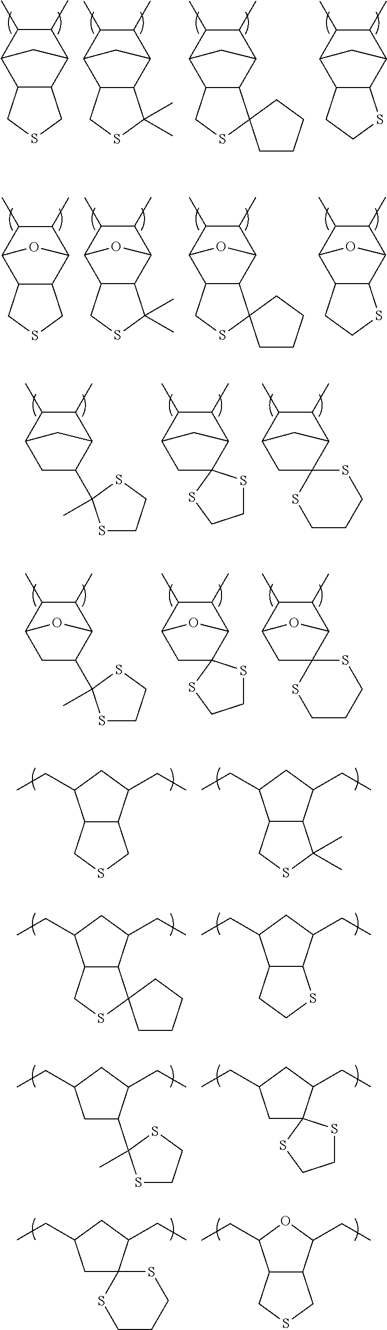

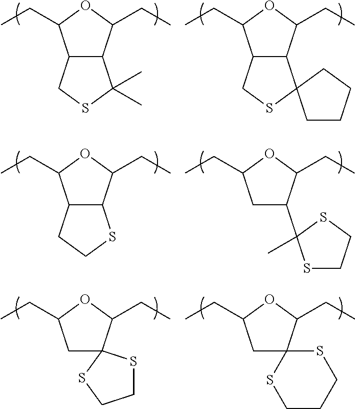

Preferable examples of the ether-containing, cyclic structure-containing monomer represented by formula (1) adoptable to manufacturing of the second ether-containing cyclic structure-containing polymer of the present invention are same as the ether-containing cyclic monomer represented by formula (1) adoptable to preparing of the first ether-containing cyclic structure-containing polymer of the present invention.

In the second ether-containing cyclic structure-containing polymer of the present invention, ratio of the ether-containing cyclic monomer represented by formula (2) is not specifically limited. The ratio of the monomer represented by formula (2) is preferably 20 to 80 mol %, and more preferably 30 to 70 mol %.

### (3) Third Ether-Containing Cyclic Structure-Containing Polymer

The present invention relates to a polymer derived from the ether-containing cyclic monomer represented by formula (1), and a monomer represented by formula (3) below, and having a refractive index of equal to or larger than 1.42 and an Abbe number of equal to or larger than 65 (referred to as “third ether-containing cyclic structure-containing polymer”, hereinafter).

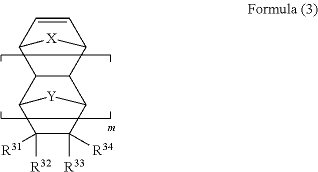

In formula (3), each of R³¹ to R³⁴ independently represents a hydrogen atom, fluorine atom, substituted or non-substituted alkyl group, fluorine atom-containing alkyl group, fluorine atom-containing alkoxy group, fluorine atom-containing ether bond-containing alkyl group, —COOR⁵, or —OCOR⁵. R³¹ to R³⁴ may bond with each other to form a cyclic structure, where, at least one of R³¹ to R³⁴ contains a fluorine atom. R⁵ represents a substituted or non-substituted alkyl group, or fluorine atom-containing alkyl group. Each of X and Y independently represents a substituted or non-substituted, carbon atom, oxygen atom, or sulfur atom. m represents 0 or 1.

Preferable examples of the substituted or non-substituted alkyl group respectively represented by R³¹ to R³⁴ are same as those of the substituted or non-substituted alkyl group respectively represented by R¹¹ to R¹⁴ in formula (1). The same will apply also to the number of carbon atoms, and the preferable examples of the substituent.

The fluorine atom-containing alkyl group respectively represented by R³¹ to R³⁴ may typically be written as —CₚF_{2p+1-q}H_{q}, where p is an integer of 1 or larger, and q is an integer of 0 or larger and 2p or smaller. p is preferably an integer of 1 to 10. A perfluoroalkyl group with q=0 is preferable.

The fluorine atom-containing alkoxy group respectively represented by R³¹ to R³⁴ may typically be written as —OCₚF_{2p+1-q}H_{q}, where p is an integer of 1 or larger, and q is an integer of 0 or larger and 2p or smaller. p is preferably an integer of 1 to 10. A perfluoroalkoxy group with q=0 is preferable.

The fluorine atom-containing ether bond-containing alkyl group respectively represented by R³¹ to R³⁴ may typically be written as —CₐF_{2a-b}H_{b}—O—CₚF_{2p+1-q}H_{q}, where a is an integer of 1 or larger, b is an integer of 0 or larger and 2a or smaller, p is an integer of 1 or larger, and q is an integer of 0 or larger and 2p+1 or smaller, excluding the case where both of b=2a and q=2p+1 hold. Each of a and p is preferably an integer of 1 to 10. A perfluoroalkylene group with b=0 may be contained, and/or perfluoroalkyl group with q=0 may be contained.

In formula (3), R⁵ in —COOR⁵ or —OCOR⁵, respectively represented by R³¹ to R³⁴, represents a substituted or non-substituted alkyl group, or fluorine atom-containing alkyl group. Preferable examples of the substituted or non-substituted alkyl group represented by R⁵ are same as those of the substituted or non-substituted alkyl group respectively represented by R¹¹ to R¹⁴ in formula (1). The same will apply also to the preferable ranges of the number of carbon atoms, and preferable examples of the substituents. Preferable examples of the fluorine atom-containing alkyl group represented by R⁵ are same as those of the fluorine atom-containing alkyl group respectively represented by R³¹ to R³⁴. The same will apply also to the preferable ranges.

R³¹ to R³⁴ may bond with each other to form a cyclic structure, which is preferably a 5-membered ring. Examples of the ring include the followings. Note that, “*” in the formula indicates a site of bonding with the ring structure illustrated in formula (3).

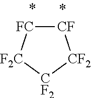

At least one of R³¹ to R³⁴ in formula (3) contains fluorine atom(s). At least one of R³¹ to R³⁴ is preferably a C₁₋₁₀ perfluoroalkyl group.

Preferable examples of the repeating unit derived from the monomer represented by formula (3), adoptable to the present invention, will be enumerated below, but are not limited thereto.

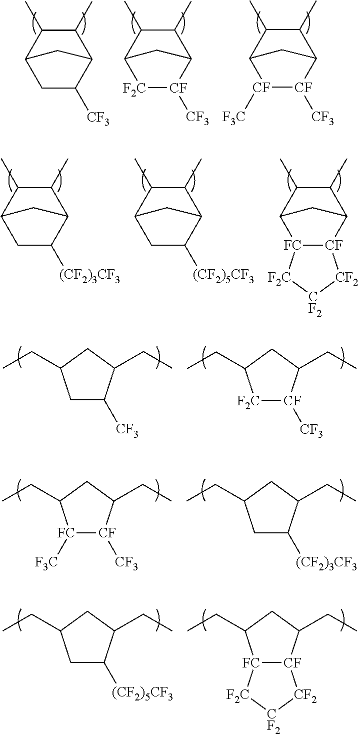

Preferable examples of the ether-containing cyclic monomer represented by formula (1), adoptable to preparing of the third ether-containing cyclic structure-containing polymer of the present invention, are same as those of the ether-containing, cyclic structure-containing monomer represented by formula (1), adoptable to preparing of the first ether-containing cyclic structure-containing polymer of the present invention.

In the third ether-containing cyclic structure-containing polymer of the present invention, ratio of the monomer represented by formula (3) is not specifically limited. The ratio of the monomer represented by formula (3) is preferably 20 to 80 mol %, and more preferably 30 to 70 mol %.

### (4) Methods of Preparing the Ether-Containing Cyclic Structure-Containing Polymer of the Present Invention

Methods of preparing the first, second and third ether-containing cyclic structure-containing polymers:(an expression of “ether-containing cyclic structure-containing polymer” hereinafter will be understood to cover all of the first, second and third ether-containing cyclic structure-containing polymers) of the present invention are not specifically limited, to which generally-known addition polymerization and ring-opening polymerization may be adoptable.

Also various cyclic olefinic monomers used in the present invention may be prepared according to any method not specifically limited, and may be synthesized according to any method found in literatures, including a method described in Bull. Chem. Soc. Jpn., 48, 3641-3644 (1975), and a method described in J. Chem. Soc. Perkin Trans., 2, 17-22 (1974). The methods are, however, not limited thereto.

The ether-containing cyclic structure-containing polymer of the present invention may be prepared according to the method described below. A specific cyclic olefinic compound may be obtained by (co)polymerization, using a cationic complex of Group-VIII metals such as Ni, Pd and Co, or a catalyst capable of forming the cationic complex, such as [Pd(CH₃CN)₄][BF₄]₂, di-p-chloro-bis-(6-methoxybicyclo[2.2.1]hepto-2-ene-endo-5σ,2π)-Pd (abbreviated as “I”, hereinafter) and methylalmoxane (MAO), “I” and AgBF₄, “I” and AgSbF₆, [(η3-allyl)PdCl]₂ and AgSbF₆, [(η3-allyl)PdCl]₂ and AgBF₄, [(θ3-crotyl)Pd(cyclooctadiene)][PF₆], [(η3-crotyl)Ni(cyclooctadiene)][B((CF₃)₂C₆H₄)₄], [NiBr(NPMe₃)]₄ and MAO, Ni(octoate)₂ and MAO, Ni(octoate)₂ and B(C₆F₅)₃ and AlEt₃, Ni(octoate)₂ and [ph₃C][B(C₆F₅)₄] and Al(i-Bu)₃, Co(neodecanoate) and MAO; in a solvent selected from alicyclic hydrocarbon solvents such as cyclohexane, cyclopentane and methyl cyclopentane; aliphatic hydrocarbon solvents such as pentane, hexane, heptane and octane; aromatic hydrocarbon solvents such as toluene, benzene and xylene; halogenated hydrocarbon solvents such as dichloromethane, 1,2-dichloroethylene and chlorobenzene; and polar solvents such as ethyl acetate, butyl acetate, γ-butyrolactone, propylene glycol dimethyl ether and nitromethane; at a temperature ranging from −20 to 100° C.

Also the methods described in Macromolecules, 1996, Vol. 29, p. 2755, Macromolecules, 2002, Vol. 35, p. 8969, and International Patent WO2004/7564 may preferably be adoptable.

According to the method making use of addition polymerization reaction, the ether-containing cyclic structure-containing polymer of the present invention may be manufactured by allowing the reaction to proceed in a solvent such as toluene, hexane, chlorobenzene or the like, at a reaction temperature of −50 to 200° C. or around, for 0.5 to 10 hours or around, and under the presence of a catalyst such as Pd complex. The conditions are, however, not limited thereto. Adoption of addition polymerization reaction is preferable from the viewpoints of heat resistance and Abbe number.

Exemplary processes of manufacturing cyclic olefinic polymers, making use of addition polymerization reaction, are detailed in, and may be referred to, Published Japanese Translation of PCT International Publication for Patent Application No. 2005-527696.

On the other hand, according to the method making use of ring-opening polymerization reaction, the ether-containing cyclic structure-containing polymer of the present invention may be manufactured by allowing the reaction to proceed in a solvent such as toluene, hexane, chlorobenzene or the like, at a reaction temperature of −50 to 200° C. or around, for 0.5 to 10 hours or around, under the presence of a catalyst such as Grubbs catalyst, followed by hydrogenation. The hydrogenation is preferably carried out under conditions ranging from normal temperature to higher temperature, and from normal pressure to higher pressure. The conditions are, however, not limited thereto. Adoption of ring-opening polymerization reaction is preferable from the viewpoint of moldability. Exemplary processes of manufacturing cyclic olefinic polymers, making use of ring-opening polymerization reaction, are detailed in, and may be referred to, Japanese Laid-Open Patent Publication No. 2007-9178 and so forth.

Molecular weight of the ether-containing cyclic structure-containing polymer of the present invention is preferably 20,000 or larger in terms of weight-average molecular weight, and more preferably 23,000 or larger. A good moldability may be ensured in this range. The upper limit value of the molecular weight may be 500,000 in general, although not specifically limited. The molecular weight may be adjustable both in addition polymerization reaction and in ring-opening polymerization reaction, by using a chain transfer agent such as 1-olefin.

### (5) Properties of the Ether-Containing Cyclic Structure-Containing Polymer of the Present Invention

The first ether-containing cyclic structure-containing polymer has a refractive index of equal to or larger than 1.53 and an Abbe number of equal to or larger than 56; the second ether-containing cyclic structure-containing polymer has a refractive index of equal to or larger than 1.55 and an Abbe number of equal to or larger than 50; and the third ether-containing cyclic structure-containing polymer has a refractive index of equal to or larger than 1.42 and an Abbe number of equal to or larger than 65.

All of the ether cyclic structure-containing polymers of the present invention which satisfy these characteristics are preferably adoptable to optical component, in particular to lens. Among others, they are suitable for mobile camera lenses to which especially large Abbe number and refractive index are required.

The ether-containing cyclic structure-containing polymer of the present invention preferably has a glass transition temperature of 100° C. or higher. The polymer having a glass transition temperature of 100° C. or higher is preferable in terms of environmental durability. The upper limit value may be 300° C. or lower in general, although not specifically limited.

The ether-containing cyclic structure-containing polymer of the present invention, intended for use as a material composing optical components such as lens, preferably shows high transparency in the visible light region. More specifically, characteristics below may preferably be satisfied. The polymer is subjected to compression molding to thereby manufacture a sample in a form of small test piece of 1 mm thick. The test piece preferably has a transmissivity of light of equal to or larger than 50% at 589 nm, more preferably equal to or larger than 60%, still more preferably equal to or larger than 70%, and ideally 100%.

### 2. Polymer Composition for Optical Material

The present invention also relates to a polymer composition for optical material, containing at least one species of the ether-containing cyclic structure-containing polymer of the present invention.

The polymer composition may contain a single or more species of additives together with the ether-containing cyclic structure-containing polymer of the present invention so far as the effects of the present invention are not degraded. Examples of the additives include plasticizer, mold releasing agent, UV absorber, flame retarder, and so forth.

The additives are preferably selected from materials unlikely to degrade the transparency of the ether-containing cyclic structure-containing polymer of the present invention. More specifically, when the polymer composition is molded into a small test piece of 1 mm thick by compression molding or injection molding, and measured at 589 nm, the transmissivity of light is preferably 50% or larger, more preferably 60% or larger, still more preferably 70% or larger, and ideally 100%.

3. Applications of the Ether-Containing Cyclic Structure-Containing Polymer and Polymer composition for Optical Material of the Present Invention

The ether-containing cyclic structure-containing polymer and polymer composition for optical material of the present invention may be adoptable to various applications, generally in a form of molded article having a desired geometry, after being molded by various method. Methods of molding are not specifically limited, and those suitable for geometries required for respective applications may be selectable. The ether-containing cyclic structure-containing polymer and the polymer composition for optical material containing the same, according to the present invention, are also excellent in the moist-heat resistance enough to avoid coloration or clouding due to thermal degradation, and are therefore advantageous even if they are molded by the methods associated with exposure to heat. They are also excellent in mold releasing property, and are therefore advantageous in the molding methods using dies. More specifically, they are advantageously adoptable to compression molding or injection molding.

As has been described in the above, the ether-containing cyclic structure-containing polymer and the polymer composition for optical material containing the same, according to the present invention, are suitable for source materials of optical components including lens base (for example, lenses composing spectacle lens, lens for optical instruments, optoelectronic lens, lens for laser instruments, optical pickup lens, vehicle-borne camera lens, mobile camera lens, digital camera lens, OHP lens, micro-lens array, etc.). In particular, they are suitable as the source materials for mobile camera lens, vehicle-borne camera lens, digital camera lens and so forth, to which large Abbe number and refractive index are required.

### EXAMPLES

Paragraphs below will further specifically explain the present invention referring to Examples and Comparative Examples, without limiting the present invention. The lubricant compositions in Examples and Comparative Examples were evaluated according to the methods described below.

### [Methods of Analysis and Evaluation]

Analyses and evaluation in Examples were conducted according to the methods below.

### (1) Measurement of Transmissivity of Light

The resin to be measured was molded by compression molding into a test piece of 1.0 mm thick, and was measured using a UV/visible spectrophotometer (“UV-3100” from Shimadzu Corporation).

### (2) Measurement of Refractive Index

Refractive index was measured using an Abbe refractometer (“DR-M2” from ATAGO Co., Ltd.) at 589 nm.

### (3) Measurement of Molecular Weight

Molecular weight was measured by GPC under conditions listed below, and expressed by weight-average molecular weight in terms of polystyrene equivalence.
Apparatus: HLC-8121GPC/HT (from TOSOH Corporation)
Column: TSK_{gel} GMH_{HR}-H (20)HT (7.8 mm×300 mm)×2
Detector: HLC-8221GPC/HT with a built-in RI detector
Solvent: o-dichlorobenzene
Flow rate: 1 mL/min
Temperature: 145° C.
Sample volume: 500 μL (0.2% solution)
Standard: monodisperse polystyrene×16 (from TOSOH Corporation)

### (4) Measurement of Glass Transition Temperature (Tg)

Glass transition temperature (also referred to as “Tg”, hereinafter) of the samples was measured using a differential scanning calorimeter (DSC6200, from Seiko Instruments; Inc.) in a nitrogen atmosphere, at a rate of temperature elevation of 10° C./min. Tg values defined in this patent specification are conforming to this way of measurement.

### [Syntheses of Ether-Containing Cyclic Structure-Containing Polymers]

### (1) Syntheses of Ether Cyclic Structure-Containing Polymers (P-1, P-2, P-3)

In a reaction vessel, 750 ml of dehydrated pyridine and 174.5 g (1.07 mol) of 5-norbornene-2-exo,3-exo-dimethanol were placed, the mixture was heated to 40° C. under nitrogen flow, and 135 g (1.17 mol) of methanesulfonyl chloride was dropped thereinto over one hour. The mixture was allowed to react for 12 hours, the whole portion thereof was poured into 12, L of a 5% aqueous HCl solution, and extracted three times using 2 L of ethyl acetate. The extracted organic phase was thoroughly washed with water, dried over anhydrous magnesium sulfate, filtered, and concentrated. The concentrated residue was purified by column chromatography using a mixed solvent of ethyl acetate/hexane (5/95 by volume), to thereby obtain 125 g of M-1 as a colorless clear liquid.

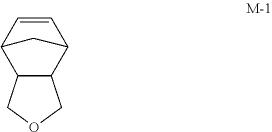

In a reaction vessel, 210 mL of chlorobenzene, 23 g (0.13 mol) of hexylnorbornene (C6NB), and 118 g (0.87 mol) of M-1 were placed. Next, 51 mg of catalyst S-1 dissolved in 17 mL of chlorobenzene, 108 μL of tributyl allyl tin (from Aldrich Chemical Company, Inc.), and 200 mg of dimethyl anilinium tetrakis(pentafluorophenyl)borate (from Strem Chemicals, Inc.) dissolved in 15 mL of methylene chloride were placed in the reaction vessel.

The catalyst S-1 used herein was a catalyst having the structure below, synthesized by using allyl palladium chloride dimer (from Aldrich Chemical Company, Inc.) and tricyclohexyl phosphine (from Strem Chemicals, Inc.), referring to a method described in J. Am. Chem. Soc., 118, 6225-6234 (1996).

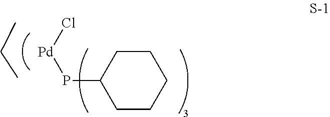

The solution was stirred at 90° C. for 11 hours under nitrogen flow. The resultant solution was diluted with 100 mL of toluene, and poured into 2 L of methanol for re-precipitation. The precipitate was collected by filtration, washed with 500 ml of acetone, dried in vacuo at 80° C. for 3 hours, to thereby obtain 89.0 g of white solid. The obtained white solid was dissolved in deuterated chloroform for ¹H-NMR measurement, and was confirmed to be P-1 with x/y=87/13 mol % (84/16% by mass).

The product was also dissolved into o-dichlorobenzene for measurement of molecular weight by gel permeation chromatography (GPC), and was confirmed to have a weight-average molecular weight (Mw) of 113,000 in terms of polystyrene equivalence. Tg was found to be 228° C. by DSC measurement.

Refractive index (nD) of the resin film, measured at 589 nm using an Abbe refractometer, was found to be 1.541, and the Abbe number (vD) was found to be 60.7. The refractive index and Abbe number herein were measured in a form of film of 200 μm thick, obtained by compression molding of P-1 under heating.

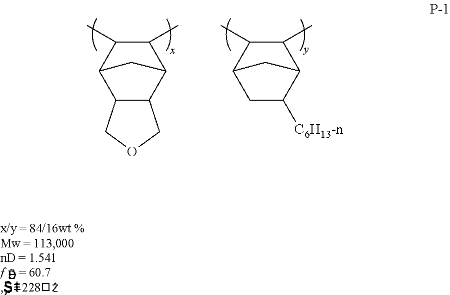

P-2 shown below was synthesized similarly to the method of synthesizing P-1, except that the monomer species, monomer concentration and catalyst concentration were modified.

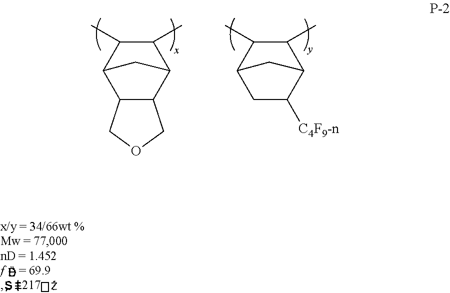

In a reaction vessel, 750 mL of dehydrated pyridine was placed, cooled to 0° C., and 270 g (2.35 mol) of methanesulfonyl choloride was dropped therein over one hour. The mixture was stirred at 0° C. for one hour, and a mixed solution of 174.5 g (1.07 mol) of 5-norbornene-2-exo, 3-exo-dimethanol and 650 ml of dehydrated pyridine was dropped therein over 3 hours. The mixture was then allowed to react at 0° C. for 15 hours, the whole portion of the reaction liquid was poured into 12 L of a 5% aqueous HCl solution, a brown deposit appeared therein was collected by filtration, and thoroughly washed with 20 L of water. The deposit was re-crystallized in ethanol, to obtain 262 g of M-2 in a form of white crystal.

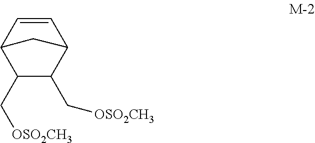

In a reaction vessel, 210 mL of chlorobenzene, 84 g (0.62 mol) of M-1, and 100 g (0.32 mol) of M-2 were placed. Next, 51 mg of catalyst S-1 dissolved in 17 mL of chlorobenzene, 108 μL of tributyl allyl tin (from Aldrich Chemical Company, Inc.), and 200 mg of dimethyl anilinium tetrakis(pentafluorophenyl)borate (from STREM Chemicals, Inc.) dissolved in 15 mL of methylene chloride were placed in the reaction vessel. The solution was stirred under nitrogen flow at 80° C. for 6 hours. The resultant solution was diluted with 150 mL of chlorobenzene, and poured into 2 L of acetone for re-precipitation. The precipitate was collected by filtration, washed with 500 mL of acetone, dried in vacuo at 80° C. for 3 hours, to thereby obtain M-1/M-2 copolymer in a form of white solid.

Next, 50 g of M-1/M-2 copolymer and 750 mL of a 1:3 mixed solvent of THF/chlorobenzene was placed in the reaction vessel. The mixture was heated to 80° C., stirred until the copolymer dissolves, and 15 mL of water and 38 g of sodium sulfide were then added. The resultant solution was stirred under nitrogen flow at 80° C. for 8 hours. The obtained solution was poured into 10 L of methanol for re-precipitation. The precipitate was collected by filtration, washed three times with 5 L of water, three times with 5 L of methanol, three times with 5 L of acetone, dried in vacuo at 80° C. for 3 hours, to thereby obtain 31.0 g of white solid. The obtained white solid was dissolved in deuterated chloroform for ¹H-NMR measurement, and was confirmed to be P-3 with x/y=62/38 mol % (59/41% by mass).

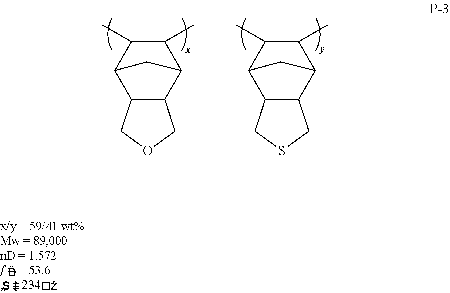

### (2) Syntheses of Ether Cyclic Structure-Containing Polymers (P-4, P-5, P-6)

In a reaction vessel, 200 mL of anhydrous methanol and 32 g (0.1 mol) of M-2 were placed, and the mixture was allowed to reflux under nitrogen flow so as to dissolve M-2. A mixture of 50 g (0.21 mol) of sodium sulfide nonahydrate and 120 mL of water was then dropped therein through a dropping funnel over on hour. After completion of dropping, the mixture was further allowed to reflux for 2 hours, cooled to room temperature, and extracted using ethyl acetate. The organic layer was washed with a 10% aqueous NaOH solution, and dried over magnesium sulfate. Magnesium sulfate was then removed by filtration, and the filtrate was concentrated in a rotary evaporator. The concentrate was purified by silica gel column chromatography using hexane as a developing solvent, to thereby obtain 12 g of M-3 as a colorless clear liquid.

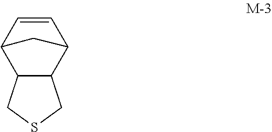

In a thoroughly dried reaction vessel, 4.1 g (0.03 mol) of M-1, 3.0 g (0.02 mol) of M-3, and 55 mL of dry chloroform were added, and the mixture was stirred under heating at 60° C. under nitrogen flow. Thereafter, a mixture of 5 mg (6 μmol) of Grubbs 2nd generation catalyst, 3.2 mL of dry chloroform, and 82 mg (0.6 mmol) of phenyl vinyl sulfide was added thereto, and the resultant mixture was stirred at 60° C. for 4 hours. The reaction liquid was cooled to room temperature, and poured into methanol for re-precipitation. The precipitate was collected by filtration and dried, to obtain a ring-opening metathesis polymer.

The thus-obtained metathesis polymer and 370 mL of o-dichlorobenzene were placed in a thoroughly dried reaction vessel, and the mixture was stirred at room temperature for thorough dissolution. The mixture was further added with 52 g (0.28 mol) of p-toluene sulfonyl hydrazide and 36 g (0.28 mol) of N,N-dimethyl cyclohexylamine, and the mixture was stirred at 110° C. for 4 hours. The reaction liquid was cooled to room temperature, and poured into methanol for re-precipitation. The obtained white solid was dissolved in deuterated chloroform for ¹H-NMR measurement, and was confirmed to be P-4 with x/y=32/68 mol % (30/70% by mass).

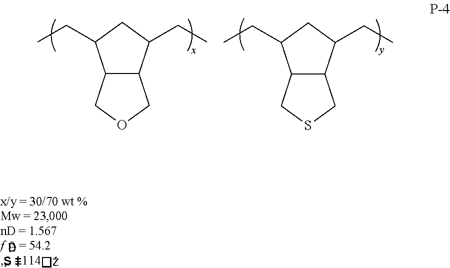

P-5 and P-6 shown below were synthesized similarly to the method of synthesizing P-4, except that the monomer species, monomer concentration and catalyst concentration were modified.

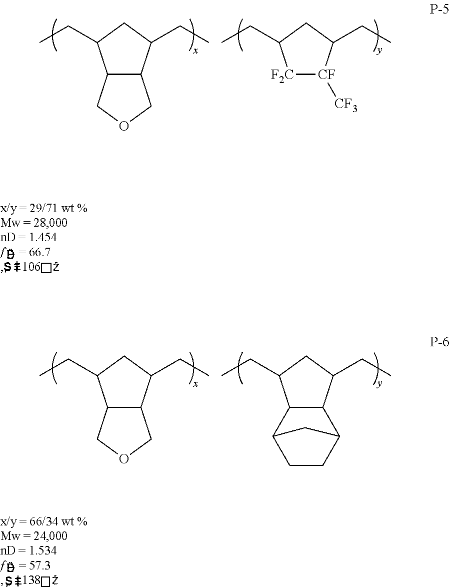

### (3) Obtainment of Comparative Polymers A, B

As comparative polymer, TOPAS5013 (Polymer A, below) from TAP Inc., and APEL5014 (Polymer B, below) from Mitsui Chemicals, Inc. were obtained.

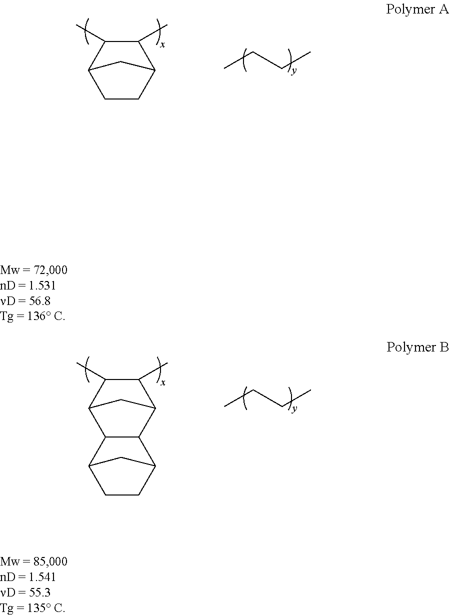

### (4) Synthesis of Comparative Polymer C

Polymer C, described in Japanese Laid-Open Patent Publication No. 2007-9178, was synthesized according to a publicly-known method.

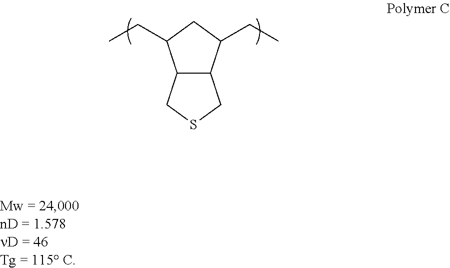

### (5) Synthesis of Comparative Polymer D

Polymer D, described in Example 1 of Japanese Laid-Open Patent Publication No. 2007-131703, was synthesized according to a publicly-known method.

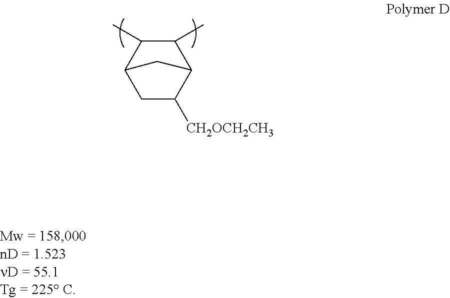

### [Preparing of Transparent Molded Article]

### (1) Preparing of Transparent Molded Article

Each of the ether-containing cyclic structure-containing polymers synthesized in the above was placed in dies, and molded under heating by compression molding (temperature: Tg+70° C., pressure: 13.7 MPa, 2 minutes), to thereby obtain a transparent molded article of 1 mm thick. Transmissivity of light and refractive index of the thus-obtained molded articles were measured. Results are shown in Table 1 below. Mold releasing property and residence in dies were also found to be desirable levels, when judged according to the criteria below. Also these results were shown in Table 1 below.

As the comparative polymers, also TOPAS5013 (Comparative Polymer A) from TAP Inc., APEL5014 (Comparative Polymer B) from Mitsui Chemicals, Inc., and the above-synthesized Comparative Polymers C and D were similarly evaluated.

(1) Mold Releasing Property from Dies

Easiness of detaching a button die from the dies, when a molded article is taken out from the stainless steel dies after molding under heating, was judged by sensory evaluation according to the criteria below:

∘: the button die naturally drops from the dies;

Δ: the button die detaches from the dies when force is applied a little;

×: the button die detaches from the dies only after a considerable level of force is applied.

### (2) Evaluation in Residence in Dies

Degree of residence of polymer on the dies, when the molded article is taken out from the stainless steel dies after molding under heating, was evaluated according to the criteria below:

∘: no residue on the dies;

Δ: a few residue on the dies; and

×: a lot of residue on the dies.

(3) Evaluation of Cracking under Moist/Heat

The molded article taken out from the dies was placed in a pressure vessel, allowed to stand at 120° C., in an atmosphere with a relative humidity of 100% for 70 hours. State of cracking was visually evaluated according to the criteria below:

∘: no crack;

Δ: only a few fine cracks;

×: a lot of fine cracks, or molded article broken.

| | Polymer | | | | | Evaluation | | | |
|---|---|---|---|---|---|---|---|---|---|
| | | | | | Weight- | | | | Cracking |
| | | | | | average | | Mold | | under |
| | | Tg | Refractive | Abbe | molecular | Transmissivity | releasing | Residue | moist/ |
| | Polymer | (° C.) | index | number | weight | (%) | property | on dies | heat |
| Example 1 | P-1 | 228 | 1.541 | 60.7 | 113000 | 77 | ∘ | ∘ | ∘ |
| Example 2 | P-2 | 217 | 1.452 | 69.9 | 77000 | 78 | ∘ | ∘ | ∘ |
| Example 3 | P-3 | 234 | 1.572 | 53.6 | 89000 | 77 | ∘ | ∘ | ∘ |
| Example 4 | P-4 | 114 | 1.567 | 54.2 | 23000 | 79 | ∘ | ∘ | ∘ |
| Example 5 | P-5 | 106 | 1.454 | 66.7 | 28000 | 80 | ∘ | ∘ | ∘ |
| Example 6 | P-6 | 138 | 1.534 | 57.3 | 24000 | 80 | ∘ | ∘ | ∘ |
| Comparative | Polymer A | 136 | 1.531 | 56.8 | 72000 | 78 | ∘ | ∘ | x |
| Example 1 | | | | | | | | | |
| Comparative | Polymer B | 135 | 1.541 | 55.3 | 85000 | 77 | ∘ | ∘ | x |
| Example 2 | | | | | | | | | |
| Comparative | Polymer C | 115 | 1.578 | 46.0 | 24000 | 76 | Δ | Δ | Δ |
| Example 3 | | | | | | | | | |
| Comparative | Polymer D | 225 | 1.523 | 55.1 | 158000 | 77 | ∘ | ∘ | ∘ |
| Example 4 | | | | | | | | | |

It can be understood from the results shown in Table 1 that, according to Examples of the present invention, optical materials capable of achieving high refractive index while keeping Abbe numbers of 50 or larger, and very excellent in the moist-heat resistance, and excellent in the transparency may be obtained. It was confirmed that the polymer composition for optical material of the present invention is excellent also in the mold releasing property, and is capable of precisely yielding lens geometries conforming to die geometries for concave lenses, convex lenses and so forth, with a good productivity.

1. An ether-containing cyclic structure-containing polymer derived from an ether-containing cyclic monomer represented by formula (1) below, or derived from an ether-containing cyclic monomer represented by formula (1) below and a single or more species of cyclic olefinic monomer(s), having a refractive index of equal to or larger than 1.53 and an Abbe number of equal to or larger than 56: 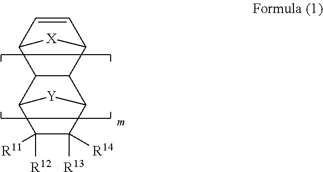
wherein each of R¹¹ to R¹⁴ independently represents a hydrogen atom, substituted or non-substituted alkyl group, or oxygen atom-containing substituent, R¹¹ to R¹⁴ may bond with each other to form a cyclic structure, where, any one of R¹¹ to R¹⁴ is a substituent containing a cyclic ether structure having oxygen atoms(s) as one of the ring-composing atoms, or alternatively, at least two of R¹¹ to R¹⁴ bond with each other to form a cyclic ether structure having oxygen atoms(s) as one of the ring-composing atoms; each of X and Y independently represents a substituted or non-substituted, carbon atom, oxygen atom, or sulfur atom; and m represents 0 or 1.

2. The ether-containing cyclic structure-containing polymer of claim 1, wherein said single or more species of cyclic olefinic monomer is a monomer represented by formula (4) below: 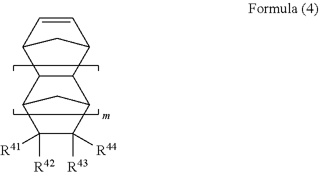
wherein each of R⁴¹ to R⁴⁴ independently represents a hydrogen atom, or substituted or non-substituted alkyl group; and m represents 0 or 1.

3. The ether-containing cyclic structure-containing polymer of claim 2, wherein said monomer represented by formula (4) is an alkyl-substituted norbornene, or a monomer represented by the formula below:

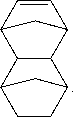

4. An ether-containing cyclic structure-containing polymer derived from the ether-containing cyclic monomer represented by formula (1), and a monomer represented by formula (2) below and/or a precursor thereof, and having a refractive index of equal to or larger than 1.55 and an Abbe number of equal to or larger than 50: 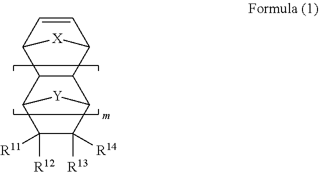
wherein each of R¹¹ to R¹⁴ independently represents a hydrogen atom, substituted or non-substituted alkyl group, or oxygen atom-containing substituent, R¹¹ to R¹⁴ may bond with each other to form a cyclic structure, where, any one of R¹¹ to R¹⁴ is a substituent containing a cyclic ether structure having oxygen atoms(s) as one of the ring-composing atoms, or alternatively, at least two of R¹¹ to R¹⁴ bond with each other to form a cyclic ether structure having oxygen atoms(s) as one of the ring-composing atoms; each of X and Y independently represents a substituted or non-substituted, carbon atom, oxygen atom, or sulfur atom; and m represents 0 or 1; 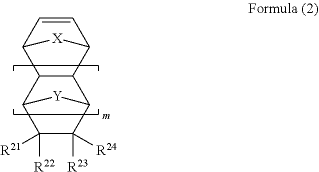
wherein each of R²¹ to R²⁴ independently represents a hydrogen atom, substituted or non-substituted alkyl group, or a substituent containing an oxygen atom or sulfur atom, R²¹ to R²⁴ may bond with each other to form a cyclic structure, where, any one of R²¹ to R²⁴ represents a substituent containing a sulfur-containing cyclic structure having sulfur atom(s) as one of the ring-composing atoms, or alternatively, any two or more of R²¹ to R²⁴ may bond with each other to form a sulfur-containing cyclic structure having sulfur atoms(s) as one of the ring-composing atoms; each of X and Y independently represents a substituted or non-substituted, carbon atom, oxygen atom, or sulfur atom; and m represents 0 or 1.

5. The ether-containing cyclic structure-containing polymer of claim 4, wherein the monomer represented by formula (2) is a compound represented by formula (2a) below, or a precursor of the monomer represented by formula (2) is a compound represented by formula (2b) below: 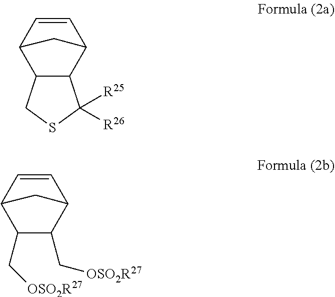
Wherein, in formula (2a), each of R²⁵ and R²⁶ independently represents a hydrogen atom, substituted or non-substituted alkyl group, and R²⁵ and R²⁶ may bond with each other to form a 5- or 6-membered alicyclic hydrocarbon ring; and in formula (2b), R²⁷ represents a C₁₋₁₀ alkyl group.

6. A polymer derived from the ether-containing cyclic monomer represented by formula (1), and a monomer represented by formula (3) below, and having a refractive index of equal to or larger than 1.42 and an Abbe number of equal to or larger than 65: 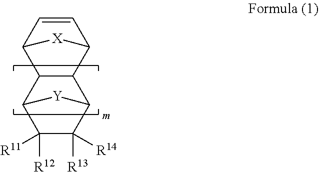
wherein each of R¹¹ to R¹⁴ independently represents a hydrogen atom, substituted or non-substituted alkyl group, or oxygen atom-containing substituent, R¹¹ to R¹⁴ may bond with each other to form a cyclic structure, where, any one of R¹¹ to R¹⁴ is a substituent containing a cyclic ether structure having oxygen atoms(s) as one of the ring-composing atoms, or alternatively, at least two of R¹¹ to R¹⁴ bond with each other to form a cyclic ether structure having oxygen atoms(s) as one of the ring-composing atoms; each of X and Y independently represents a substituted or non-substituted, carbon atom, oxygen atom, or sulfur atom; and m represents 0 or 1; 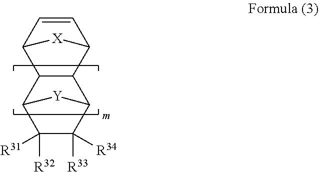
wherein each of R³¹ to R³⁴ independently represents a hydrogen atom, fluorine atom, substituted or non-substituted alkyl group, fluorine atom-containing alkyl group, fluorine atom-containing alkoxy group, fluorine atom-containing ether bond-containing alkyl group, —COOR⁵, or —OCOR⁵; R³¹ to R³⁴ may bond with each other to form a cyclic structure, where, at least one of R³¹ to R³⁴ contains a fluorine atom; R⁵ represents a substituted or non-substituted alkyl group, or fluorine atom-containing alkyl group; each of X and Y independently represents a substituted or non-substituted, carbon atom, oxygen atom, or sulfur atom; and m represents 0 or 1.

7. The ether-containing cyclic structure-containing polymer of claim 6, wherein in formula (3), at least one of R³¹ to R³⁴ represents a C₁₋₁₀ perfluoroalkyl group.

8. The ether-containing cyclic structure-containing polymer of claim 1, wherein the ether-containing cyclic monomer represented by formula (1) is a monomer represented by formula (1a) below: 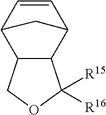
wherein each of R¹⁵ and R¹⁶ independently represents a hydrogen atom, substituted or non-substituted alkyl group, and, R¹⁵ and R¹⁶ may bond with each other to form a 5- or 6-membered alicyclic hydrocarbon ring.

9. The ether-containing cyclic structure-containing polymer of claim 1, wherein the ether-containing cyclic monomer represented by formula (1) is a monomer represented by formula M-1 below:

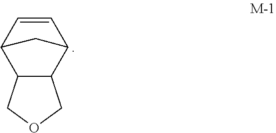

10. The ether-containing cyclic structure-containing polymer of claim 1, obtained by addition polymerization of the monomer(s).

11. The ether-containing cyclic structure-containing polymer of claim 1, obtained by ring-opening metathesis polymerization of the monomer(s), and subsequent hydrogenation.

12. The ether-containing cyclic structure-containing polymer of claim 1, having a glass transition temperature of equal to or higher than 100° C.

13. The ether-containing cyclic structure-containing polymer of claim 1, having a weight-average molecular weight of equal to or larger than 20,000.

14. A polymer composition for optical material, comprising an ether-containing cyclic structure-containing polymer derived from an ether-containing cyclic monomer represented by formula (I) below, or derived from an ether-containing cyclic monomer represented by formula (I) below and a single or more species of cyclic olefinic monomer(s), having a refractive index of equal to or larger than 1.53 and an Abbe number of equal to or larger than 56: 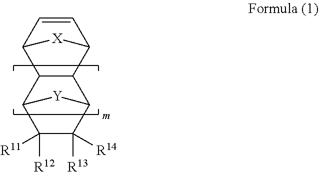
wherein each of R¹¹ to R¹⁴ independently represents a hydrogen atom, substituted or non-substituted alkyl group, or oxygen atom-containing substituent, R¹¹ to R¹⁴ may bond with each other to form a cyclic structure, where, any one of R¹¹ to R¹⁴ is a substituent containing a cyclic ether structure having oxygen atoms(s) as one of the ring-composing atoms, or alternatively, at least two of R¹¹ to R¹⁴ bond with each other to form a cyclic ether structure having oxygen atoms(s) as one of the ring-composing atoms; each of X and Y independently represents a substituted or non-substituted, carbon atom, oxygen atom, or sulfur atom; and m represents 0 or 1.

15. The ether-containing cyclic structure-containing polymer of claim 1, having a transmissivity of light of equal to or larger than 50% based on a 1-mm thick equivalence measured at a wavelength of 589 nm.

16. The polymer composition for optical material of claim 14, having a transmissivity of light of equal to or larger than 50% based on a 1-mm thick equivalence measured at a wavelength of 589 nm.

17. A molded article, obtained by molding an ether-containing cyclic structure-containing polymer derived from an ether-containing cyclic monomer represented by formula (1) below, or derived from an ether-containing cyclic monomer represented by formula (I) below and a single or more species of cyclic olefinic monomer(s), having a refractive index of equal to or larger than 1.53 and an Abbe number of equal to or larger than 56: 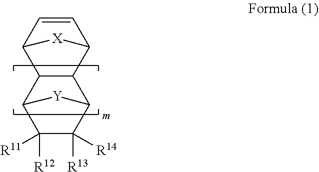
wherein each of R¹¹ to R¹⁴ independently represents a hydrogen atom, substituted or non-substituted alkyl group, or oxygen atom-containing substituent, R¹¹ to R¹⁴ may bond with each other to form a cyclic structure, where, any one of R¹¹ to R¹⁴ is a substituent containing a cyclic ether structure having oxygen atoms(s) as one of the ring-composing atoms, or alternatively, at least two of R¹¹ to R¹⁴ bond with each other to form a cyclic ether structure having oxygen atoms(s) as one of the ring-composing atoms; each of X and Y independently represents a substituted or non-substituted, carbon atom, oxygen atom, or sulfur atom; and m represents 0 or 1.

18. An optical component, obtained by molding an ether-containing cyclic structure-containing polymer derived from an ether-containing cyclic monomer represented by formula (1) below, or derived from an ether-containing cyclic monomer represented by formula (1) below and a single or more species of cyclic olefinic monomer(s), having a refractive index of equal to or larger than 1.53 and an Abbe number of equal to or larger than 56: 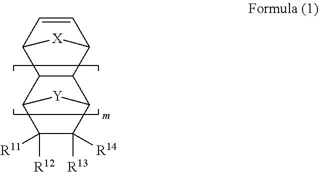
wherein each of R¹¹ to R¹⁴ independently represents a hydrogen atom, substituted or non-substituted alkyl group, or oxygen atom-containing substituent, R¹¹ to R¹⁴ may bond with each other to form a cyclic structure, where, any one of R¹¹ to R¹⁴ is a substituent containing a cyclic ether structure having oxygen atoms(s) as one of the ring-composing atoms, or alternatively, at least two of R¹¹ to R¹⁴ bond with each other to form a cyclic ether structure having oxygen atoms(s) as one of the ring-composing atoms; each of X and Y independently represents a substituted or non-substituted, carbon atom, oxygen atom, or sulfur atom; and m represents 0 or 1.

19. A lens, obtained by molding an ether-containing cyclic structure-containing polymer derived from an ether-containing cyclic monomer represented by formula (1) below, or derived from an ether-containing cyclic monomer represented by formula (1) below and a single or more species of cyclic olefinic monomer(s), having a refractive index of equal to or larger than 1.53 and an Abbe number of equal to or larger than 56: 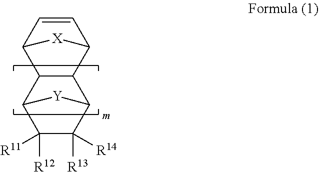
wherein each of R¹¹ to R¹⁴ independently represents a hydrogen atom, substituted or non-substituted alkyl group, or oxygen atom-containing substituent, R¹¹ to R¹⁴ may bond with each other to form a cyclic structure, where, any one of R¹¹ to R¹⁴ is a substituent containing a cyclic ether structure having oxygen atoms(s) as one of the ring-composing atoms, or alternatively, at least two of R¹¹ to R¹⁴ bond with each other to form a cyclic ether structure having oxygen atoms(s) as one of the ring-composing atoms; each of X and Y independently represents a substituted or non-substituted, carbon atom, oxygen atom, or sulfur atom; and m represents 0 or 1.

20. A molded article, obtained by molding a polymer composition for optical material comprising an ether-containing cyclic structure-containing polymer derived from an ether-containing cyclic monomer represented by formula (1) below, or derived from an ether-containing cyclic monomer represented by formula (1) below and a single or more species of cyclic olefinic monomer(s), having a refractive index of equal to or larger than 1.53 and an Abbe number of equal to or larger than 56: 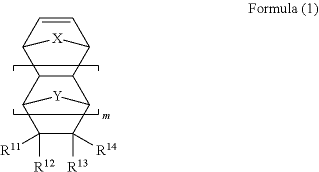
wherein each of R¹¹ to R¹⁴ independently represents a hydrogen atom, substituted or non-substituted alkyl group, or oxygen atom-containing substituent, R¹¹ to R¹⁴ may bond with each other to form a cyclic structure, where, any one of R¹¹ to R¹⁴ is a substituent containing a cyclic ether structure having oxygen atoms(s) as one of the ring-composing atoms, or alternatively, at least two of R¹¹ to R¹⁴ bond with each other to form a cyclic ether structure having oxygen atoms(s) as one of the ring-composing atoms; each of X and Y independently represents a substituted or non-substituted, carbon atom, oxygen atom, or sulfur atom; and m represents 0 or 1.

21. An optical component, obtained by molding a polymer composition for optical material comprising an ether-containing cyclic structure-containing polymer derived from an ether-containing cyclic monomer represented by formula (1) below, or derived from an ether-containing cyclic monomer represented by formula (1) below and a single or more species of cyclic olefinic monomer(s), having a refractive index of equal to or larger than 1.53 and an Abbe number of equal to or larger than 56: 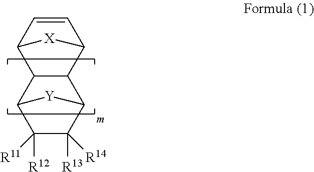
wherein each R¹¹ to R¹⁴ independently represents a hydrogen atom, substituted or non-substituted alkyl group, or oxygen atom-containing substituent, R¹¹ to R¹⁴ may bond with each other to form a cyclic structure, where, any one of R¹¹ to R¹⁴ is a substituent containing a cyclic ether structure having oxygen atoms(s) as one of the ring-composing atoms, or alternatively, at least two of R¹¹ to R¹⁴ bond with each other to form a cyclic ether structure having oxygen atoms(s) as one of the ring-composing atoms; each of X and Y independently represents a substituted or non-substituted, carbon atom, oxygen atom, or sulfur atom; and m represents 0 or 1.

22. A lens, obtained by molding a polymer composition for optical material comprising an ether-containing cyclic structure-containing polymer derived from an ether-containing cyclic monomer represented by formula (1) below, or derived from an ether-containing cyclic monomer represented by formula (1) below and a single or more species of cyclic olefinic monomer(s), having a refractive index of equal to or larger than 1.53 and an Abbe number of equal to or larger than 56: 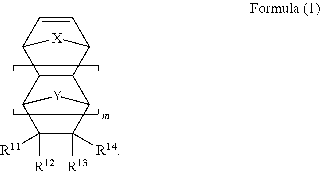
wherein each of R¹¹ to R¹⁴ independently represents a hydrogen atom, substituted or non-substituted alkyl group, or oxygen atom-containing substituent, R¹¹ to R¹⁴ may bond with each other to form a cyclic structure, where, any one of R¹¹ to R¹⁴ is a substituent containing a cyclic ether structure having oxygen atoms(s) as one of the ring-composing atoms, or alternatively, at least two of R¹¹ to R¹⁴ bond with each other to form a cyclic ether structure having oxygen atoms(s) as one of the ring-composing atoms; each of X and Y independently represents a substituted or non-substituted, carbon atom, oxygen atom, or sulfur atom; and m represents resents 0 or 1.
